(19) United States
(12) Patent Application Publication
(10) Pub. No.: US 2008/0059026 A1
(43) Pub. Date: Mar. 6, 2008

(54) VEHICLE STEERING CONTROL SYSTEM

(76) Inventor: Satoru Akiyama, Tokyo (JP)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/846,206

(22) Filed: Aug. 28, 2007

(30) Foreign Application Priority Data
Aug. 29, 2006 (JP) 2006-232673

(51) Int. Cl. B62D 6/00

(52) U.S. Cl. 701/41

(57) ABSTRACT

A vehicle steering control system is provided in which a power steering mechanism provides adequate assistance to a steering reactive force even when a steering angle correction mechanism is actuated in addition to a vehicle operator's steering operation, thereby maintaining a feeling of stable steering without causing the operator to feel unusual. Considering a correction amount of front wheel steering angle provided by an auxiliary steering control section, a power steering control section corrects an assist current from an assist current map prepared based on a vehicle speed and a steering torque, the correction of which is made by converting the correction amount of front wheel steering angle into a correction amount of power steering electric motor current to correct the assist current, or into a vehicle speed correction amount to correct the vehicle speed.

### CROSS REFERENCE TO RELATED APPLICATION

The disclosure of Japanese Application NO. 2006-232673 filed on Aug. 29, 2006 including the specification, drawing and abstract are incorporated by reference herein.

### BACKGROUND OF THE INVENTION

1. Field of the Invention

The present invention relates to a vehicle steering control system which includes a steering angle correction mechanism which can freely steer the front wheels independently of a vehicle operator's steering operation and a power steering mechanism for alleviating steering torque.

2. Related Art

Recently, for application in vehicles, various steering control systems have been developed into practical use, which include a steering angle correction mechanism which can freely steer the front wheels independently of a vehicle operator's steering operation. Those vehicles also include a conventional power steering mechanism.

For example, a vehicle disclosed in Japanese Patent Laid-Open Publication No. Hei 7-47969 has an automatic steering mechanism provided in parallel to a steering-wheel system the vehicle operator steers, and utilizes a power steering mechanism for automatic steering. This vehicle is configured to switch between a steering assist active mode for actuating the power steering mechanism in response to a steering force from the vehicle operator and an automatic steering active mode for actuating it in response to a steering force setting from the automatic steering mechanism.

However, the technique disclosed in Japanese Patent Application Laid-Open No. Hei 7-47969 above is configured to switch between the steering assist active mode and the automatic steering active mode, and cannot provide steering control for performing these modes in parallel, i.e., such control that allows a steering angle correction mechanism to make a correction to the vehicle operator's steering. It is thus not possible for the power steering mechanism to provide adequate assistance to the steering force. For example, since the power steering mechanism provides a constant assist torque, an increase in reactive force may change the feeling of steering when the steering angle correction mechanism is actuated in addition to a vehicle operator's steering operation, thereby possibly causing the vehicle operator to feel unusual.

### SUMMARY OF THE INVENTION

It is therefore an object of the present invention to provide a vehicle steering control system which allows a power steering mechanism to provide adequate assistance to a steering reactive force even when a steering angle correction mechanism is actuated in addition to a vehicle operator's steering operation, thereby maintaining a feeling of stable steering without causing the vehicle operator to feel unusual.

The present invention provides a vehicle steering control system which includes: a power steering mechanism to alleviate steering torque, a steering angle correction mechanism for steering front wheels independently of a vehicle operator's steering operation; a power steering control means for computing an assist power amount to alleviate steering torque of the power steering mechanism; an auxiliary steering control means for computing a steering angle correction amount to operate the steering angle correction mechanism, in the vehicle steering control system, the power steering control means corrects said assist power amount based on said steering angle correction amount.

According to the vehicle steering control system of the present invention, even when the steering angle correction mechanism is actuated in addition to a vehicle operator's steering operation, the power steering mechanism advantageously provides adequate assistance to a steering reactive force, thereby maintaining a feeling of stable steering without causing the vehicle operator to feel unusual.

### BRIEF DESCRIPTION OF THE DRAWINGS

These and other objects and advantages of the present invention will become clear from the following description with reference to the accompanying drawings, wherein:

FIG. 1 is an explanatory schematic view illustrating the configuration of a vehicle front wheel steering system in accordance with a first embodiment of the present invention;

FIG. 2 is a flowchart of an auxiliary steering control program in accordance with the first embodiment;

FIG. 3 is a flowchart of a power steering control program in accordance with the first embodiment;

FIG. 4 is a characteristic diagram of a vehicle speed responsive steering gear ratio in accordance with the first embodiment;

FIG. 5 is a characteristic diagram of a control gain in accordance with the first embodiment;

FIG. 6 is an explanatory view illustrating an assist current map which is determined by vehicle speeds and steering torques in accordance with the first embodiment; and

FIG. 7 is a flowchart of a power steering control program in accordance with a second embodiment of the present invention.

### DETAILED DESCRIPTION OF THE PREFERRED EMBODIMENTS

Now, the present invention will be described below in more detail with reference to the accompanying drawings in accordance with the embodiments.

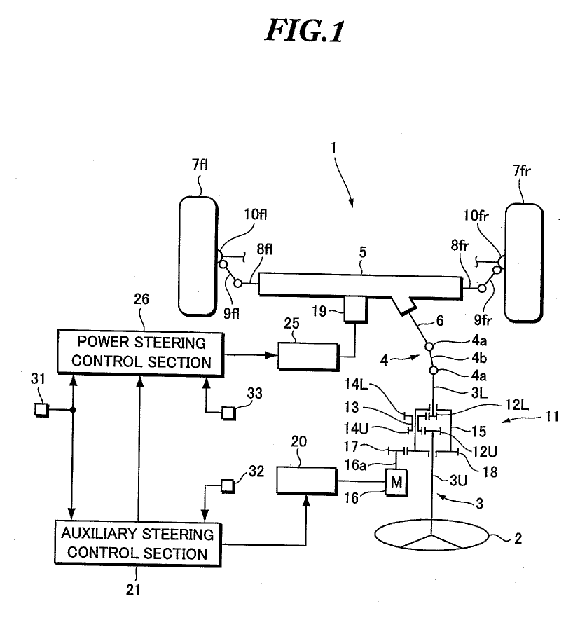

In FIG. 1, reference numeral 1 indicates a vehicle front wheel steering system. The front wheel steering system 1 is configured such that a steering shaft 3 extends from a steering wheel 2, and the front end of the steering shaft 3 is coupled to a pinion shaft 6 protruding from a steering gear box 5 via a joint portion 4 which includes universal joints 4a and a joint shaft 4b.

The steering gear box 5 has a tie rod 8fl extending therefrom toward a left front wheel 7fl as well as a tie rod 8fr extending toward a right front wheel 7fr.

The tie rod ends of the tie rods 8fl and 8fr are coupled via knuckle arms 9f1 and 9fr to axle housings 10fl and 10fr for rotatably supporting traction wheels 7fl and 7fr, respectively.

At a certain midpoint on the steering shaft 3, there is interposed a front wheel steering angle correction mechanism 11 for providing variable steering gear ratios. The steering shaft 3 is configured such that one shaft portion extending upwardly from the front wheel steering angle correction mechanism 11 serves as an upper shaft 3U and the other shaft portion extending downwardly from the front wheel steering angle correction mechanism 11 serves as a lower shaft 3L.

A description will now be made to the configuration of the front wheel steering angle correction mechanism 11. A pair of sun gears 12U and 12L are secured to the lower end of the upper shaft 3U and the upper end of the lower shaft 3L about the same axial center of rotation, respectively. The pair of sun gears 12U and 12L are engaged with planetary gears 14U and 14L, respectively, which are secured on a plurality of (for example, three) pinion shafts 13.

The pair of sun gears 12U and 12L are housed together inside a carrier 15 which rotatably supports the pinion shafts 13. On the outer circumference of the upper end of the carrier 15, there is provided a driven gear 18 which is engaged with a driving gear 17 which is secured on an output shaft 16a of an auxiliary steering electric motor 16.

The auxiliary steering electric motor 16 is driven by an auxiliary steering motor drive section 20. The auxiliary steering motor drive section 20 is designed to rotate the auxiliary steering electric motor 16 in response to the motor rotation angle which is supplied from an auxiliary steering control section 21 serving as auxiliary steering control means.

On the other hand, the front wheel steering system 1 is provided with an electric power steering mechanism 19 such as of a well-known rack-assist type. A power steering electric motor (not shown) of the electric power steering mechanism is driven by a power steering motor drive section 25. The power steering motor drive section 25 drives the power steering electric motor in response to a signal from a power steering control section 26 serving as power steering control means.

The vehicle is provided with a vehicle speed sensor 31 for detecting a vehicle speed V, a steering wheel angle sensor 32 for detecting a steering angle (steering wheel angle) θHd determined by the vehicle operator, and a steering torque sensor 33 for detecting a steering torque TH. Those signals indicative of the vehicle speed V and the steering wheel angle θHd are supplied to the auxiliary steering control section 21, while those signals indicative of the vehicle speed V and the steering torque TH are supplied to the power steering control section 26.

The auxiliary steering control section 21 also computes a correction amount δHc of front wheel steering angle (to be discussed in more detail later), which is in turn supplied to the power steering control section 26.

Following an auxiliary steering control program (discussed later), the auxiliary steering control section 21 computes a first correction amount δHc1 of front wheel steering angle based on the vehicle speed V and the steering wheel angle θHd. A low-pass filtered value of the differential value of the steering wheel angle θHd is then multiplied by a control gain corresponding to the vehicle speed V to yield a second correction amount δHc2 of the front wheel steering angle. Then, a motor rotation angle θM is computed according to the correction amount δHc of front wheel steering angle obtained by adding them together, and delivered to the auxiliary steering motor drive section 20 to drive the auxiliary steering electric motor 16.

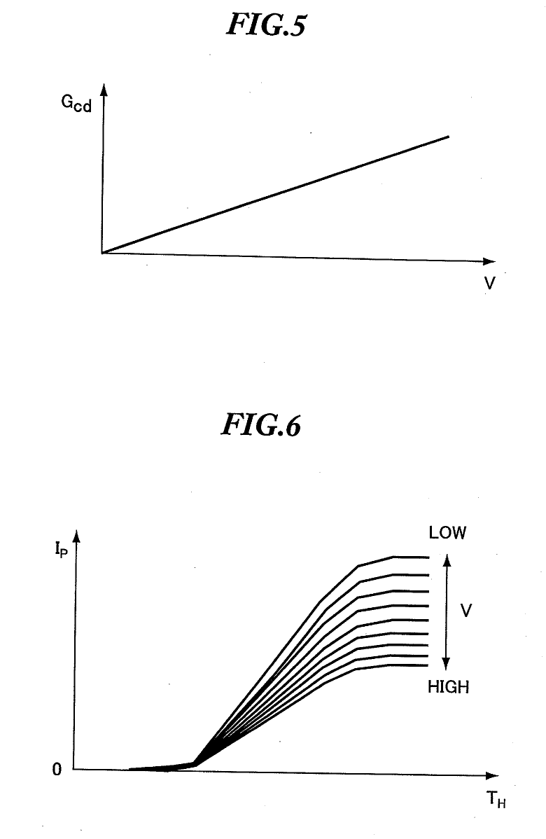

Additionally, following a power steering control program (discussed later) and considering a correction or the correction amount δHc of front wheel steering angle, the power steering control section 26 refers to a pre-set assist current map (for example, FIG. 6) determined by the vehicle speed and the steering torque to find an assist current Ip, which is in turn delivered to the power steering motor drive section 25 to drive the power steering electric motor.

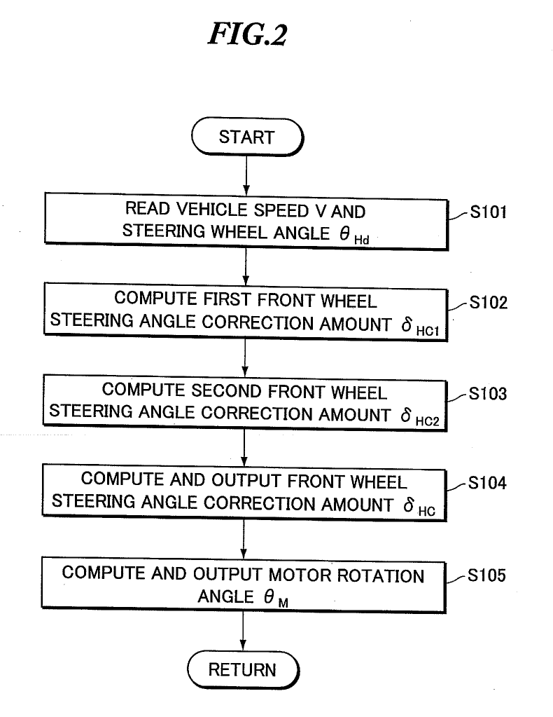

Now, reference will be made to the flowchart of FIG. 2 to describe the auxiliary steering control program which is executed by the auxiliary steering control section 21.

To begin with, in step (hereinafter simply refereed to as “S”) 101, the process reads the vehicle speed V and the steering angle θHd determined by the vehicle operator.

Then, the process proceeds to S102, where the first correction amount δHc1 of front wheel steering angle is computed, for example, by Equation (1) below.

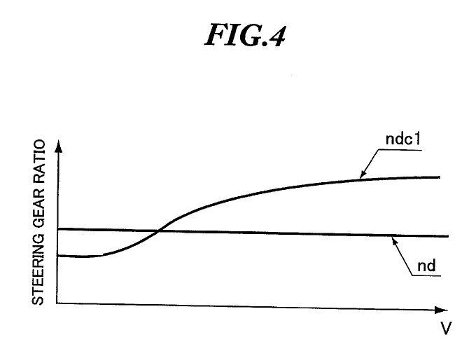

δHc1=((θHd/ndc1)−(θHd/nd))·nc (1)

where nd is the steering gear ratio on the vehicle operator side (the steering gear ratio which affects the vehicle operator's steering operation when the auxiliary steering electric motor 16 is stopped; or the steering gear ratio which is determined by the pair of sun gears 12U and 12L, the pair of planetary gears 14U and 14L, and the steering gear box 5). Furthermore, in the equation above, nc is the steering gear ratio on the side of front wheel steering angle correction mechanism 11 (the steering gear ratio which comes into effect when the auxiliary steering electric motor 16 rotates in the absence of a vehicle operator's steering operation; or the steering gear ratio determined by the driving gear 17 and the driven gear 18 (carrier)). Still furthermore, ndc1 is the vehicle speed responsive steering gear ratio which is obtained by a pre-set map or an arithmetic expression. For example, the vehicle speed responsive steering gear ratio ndc1 is set as shown in FIG. 4, to have a quick property at lower vehicle speeds V relative to the vehicle operator side steering gear ratio nd and a slow property at higher vehicle speeds V relative to the vehicle operator side steering gear ratio nd.

The process then proceeds to S103, where the second correction amount δHc2 of front wheel steering angle is computed, for example, by Equation (2) below.

δHc2=Gcd·(1/(1+Tcd·S))·(dθHd/dt)/nd (2)

where Gcd is the control gain, Tcd is the time constant of the low-pass filter, S is the Laplace operator, and (dθHd/dt) is the differential value of the front wheel steering angle.

Accordingly, Equation (2) above shows that the differential value of the front wheel steering angle (dθHd/dt) is multiplied by (1/(1+Tcd·S)) for low-pass filtering. The time constant Tcd of the low-pass filter is provided with a setting, 1 to 2 Hz, or a yaw rate response resonant frequency for an input front wheel steering angle.

On the other hand, as shown in FIG. 5, the control gain Gcd is set with reference to the map or the like to a larger value as the vehicle speed V increases because the property having a sudden peak for a steering frequency becomes more noticeable as the vehicle speed V increases.

Then, the process proceeds to S104, where the first correction amount δHc1 of front wheel steering angle and the second correction amount δHc2 of front wheel steering angle are added together to yield the correction amount δHc of front wheel steering angle, which is in turn delivered to the power steering control section 26. That is,

δHc=δHc1+δHc2 (3)

Then, the process proceeds to S105, where the motor rotation angle θM is computed by Equation (4) below, and then delivered to the auxiliary steering motor drive section 20. After that, the process exits the program.

θM=δHc·nc (4)

That is, according to the auxiliary steering control of the first embodiment, the differential value of the front wheel steering angle (dθHd/dt) is low-pass filtered to provide a property having no distinct peak (the property according to the present embodiment) while the gain is gradually increased with the steering frequency. This allows for improving the response to a quick steering and realizing stability (to prevent the vehicle from spinning). It is thus ensured to suppress unstable vehicle behaviors which would be otherwise caused by the resonance between the steering and the yaw motion, while improving the vehicle's yaw response.

The low-pass filtering of the differential value of the front wheel steering angle (dθHd/dt) will also serve to eliminate those noise components which would possibly become problematic when the digital value of steering angles is differentiated.

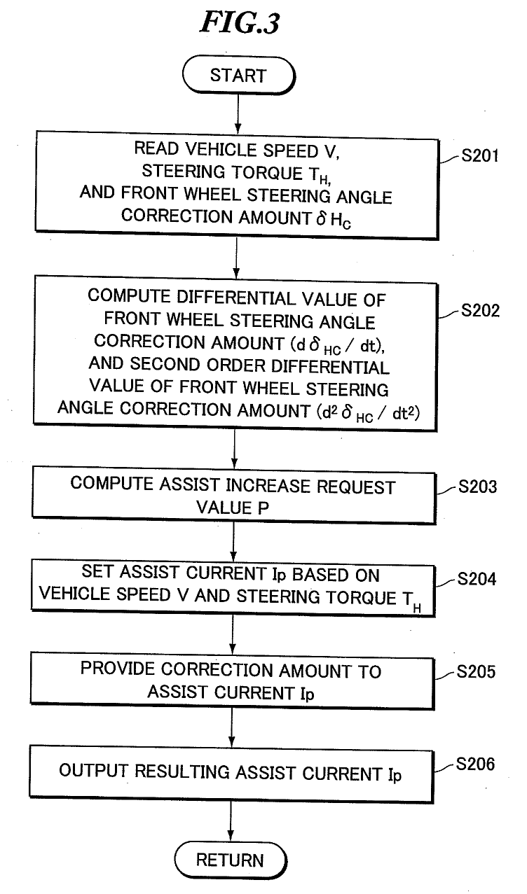

Now, reference is made to the flowchart of FIG. 3 to describe the power steering control program to be executed in the power steering control section 26.

To begin with, in S201, the process reads the vehicle speed V, the steering torque TH, and the correction amount δHc of front wheel steering angle.

The process then proceeds to S202, where the differential value (dδHc/dt) of the front wheel steering angle correction amount and the second order differential value (d²δHc/dt²) of the front wheel steering angle correction amount are computed.

Then, the process proceeds to S203, where an assist increase request value P for correcting an assist current Ip is computed, for example, by Equation (5) below.

P=K1·δHc+K2·(dδHc/dt)+K3·(d²δHc/dt²) (5)

where K1, K2, and K3 are each a pre-set gain.

In this equation, the term “K1·δHc” indicates the assist force to cancel out the steering reactive force itself; the term “K2·(dδHc/dt)” indicates the assist force which operates to cancel out the steering damper; and the term “K3·(d²δHc/dt²)” indicates the assist force which operates to cancel out inertia during a steering operation. These terms provided as such can smoothly correct the assist force. Note that not all of these terms but any one or any two of the terms may be used to compute the assist increase request value P depending on the vehicle.

Next, the process proceeds to S204, where based on the vehicle speed V and the steering torque TH, the assist current Ip is found with reference to the pre-set assist current map (for example, FIG. 6) which is determined by the vehicle speed and the steering torque. Note that FIG. 6 shows a map which indicates either one of the right or left assist current Ip, where the property of the other assist current Ip is set in the same manner with the opposite sign.

Then, the process proceeds to S205, where the assist current Ip determined in S204 is corrected by the assist increase request value P which was computed in S203. This correction processing is performed, for example, as shown by Equation (6) below.

Ip=Ip+P (6)

Then, the process proceeds to S206, where the assist current Ip which was subjected to the correction processing in S205 is delivered to the power steering motor drive section 25. The process then exits the program.

As such, according to the first embodiment, the correction amount δHc of front wheel steering angle provided by the auxiliary steering control section 21 is converted into the correction amount (or the assist increase request value P) of power steering electric motor current (assist current Ip) to correct the assist current Ip. Accordingly, even when the front wheel steering angle correction mechanism 11 is actuated in addition to a vehicle operator's steering operation, the electric power steering mechanism 19 provides adequate assistance to the steering reactive force, thereby maintaining a feeling of stable steering without causing the vehicle operator to feel unusual.

Note that the first embodiment is adapted such that the assist increase request value P or a correction amount of assist current Ip is added to the assist current Ip for correction. However, the correction may also be made by the multiplication of the assist current Ip depending on the manner in which the assist increase request value P is computed or converted.

Additionally, in the first embodiment, the assist increase request value P is computed using the correction amount δHc of front wheel steering angle from the auxiliary steering control section 21; however, it may also be computed based not on the amount of control but on an actually measured value (sensor value).

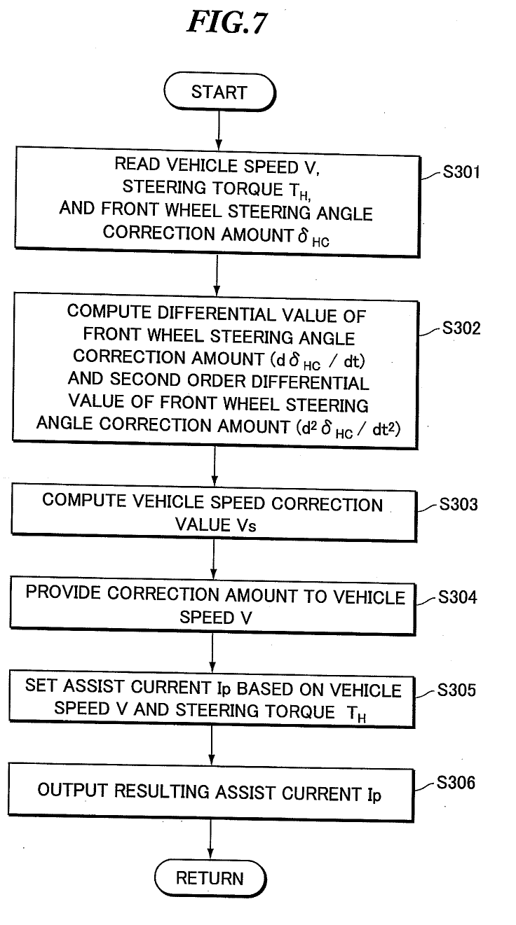

Now, FIG. 7 is a flowchart of a power steering control program in accordance with a second embodiment of the present invention. Note that the second embodiment is different from the aforementioned first embodiment in the manner in which the power steering control section 26 provides a correction to the assist current Ip, but is the same as the first embodiment in the configuration and operation, which will not be thus repeatedly mentioned here.

That is, as shown in the flowchart of FIG. 7, the power steering control program according to the second embodiment to be executed by the power steering control section 26 starts in S301, where the process reads the vehicle speed V, the steering torque TH, and the correction amount δHc of front wheel steering angle.

Then, the process proceeds to S302, where the differential value (dδHc/dt) of the front wheel steering angle correction amount and the second order differential value (d²δHc/dt²) of the front wheel steering angle correction amount are computed.

The process then proceeds to S303, where a vehicle speed correction value Vs for correcting the vehicle speed V is computed, for example, by Equation (7) below.

Vs=Kv1·δHc+Kv2·(dδHc/dt)+Kv3·(d²δHc/dt²) (7)

where Kv1, Kv2, and Kv3 are each a pre-set gain.

In the equation above, the term “Kv1·δHc” indicates the assist force to cancel out the steering reactive force itself; the term “Kv2·(dδHc/dt)” indicates the assist force which operates to cancel out the steering damper; and the term “Kv3·(d2δHc/dt2)” indicates the assist force which operates to cancel out inertia during a steering operation. These terms provided as such can smoothly correct the assist force. Note that not all of these terms but any one or any two of the terms may be used to compute the vehicle speed correction value Vs depending on the vehicle.

Next, the process proceeds to S304, where the vehicle speed V is provided with a correction by Equation (8) below.

V=V−Vs (8)

Then, the process proceeds to S305, where based on the vehicle speed V and the steering torque TH, the assist current Ip is found with reference to the pre-set assist current map (for example, FIG. 6) which is determined by the vehicle speed and the steering torque. Note that FIG. 6 shows a map which indicates either one of the right or left assist current Ip, where the property of the other assist current Ip is set in the same manner with the opposite sign.

Then, the process proceeds to S306, where the assist current Ip which was set in S305 is delivered to the power steering motor drive section 25. The process then exits the program.

As such, according to the second embodiment, the correction amount δHc of front wheel steering angle provided by the auxiliary steering control section 21 is converted into the correction amount of vehicle speed V (the vehicle speed correction value Vs) to correct the vehicle speed V, thereby making a correction to the amount of assist power. Accordingly, even when the front wheel steering angle correction mechanism 11 is actuated in addition to a vehicle operator's steering operation, the electric power steering mechanism 19 provides adequate assistance to the steering reactive force, thereby maintaining a feeling of stable steering without causing the vehicle operator to feel unusual.

Additionally, the control is provided to correct the vehicle speed V. This eliminates the need to change the assist current map which is determined by the fundamental vehicle speed and steering torque, thereby allowing an immediate application to various conventional power steering mechanisms and thus providing a wide general versatility.

Note that the second embodiment is adapted such that the vehicle speed correction value Vs is subtracted from the vehicle speed V to correct the vehicle speed; however, the vehicle speed V may also be corrected by the multiplication of the vehicle speed V depending on the manner in which the vehicle speed correction value Vs is computed or converted.

Additionally, in the second embodiment, the vehicle speed correction value Vs is computed using the correction amount δHc of front wheel steering angle from the auxiliary steering control section 21; however, it may also be computed based not on the amount of control but on an actually measured value (sensor value).

Furthermore, the auxiliary steering control in the first and second embodiments is not limited to the aforementioned ones but may also be other auxiliary steering control.

What is claimed is:

1. A vehicle steering control system comprising:
a power steering mechanism to alleviate steering torque,
a steering angle correction mechanism for steering front wheels independently of a vehicle operator's steering operation;
a power steering control means for computing an assist power amount to alleviate steering torque of said power steering mechanism;
an auxiliary steering control means for computing a steering angle correction amount to operate said steering angle correction mechanism,
wherein
said power steering control means corrects said assist power amount based on said steering angle correction amount.

2. The vehicle steering control system according to claim 1, wherein
said power steering mechanism includes an electric motor,
said power steering control means sets an assist current of said electric motor based on a steering torque and a vehicle speed, and converts said steering angle correction amount into a correction current to correct said assist current, and drives said electric motor at said assist current corrected by said correction current.

3. The vehicle steering control system according to claim 2, wherein
said correction current is set based on at least one of a steering wheel angle, a first order differential value of the steering wheel angle, and a second order differential value thereof.

4. The vehicle steering control system according to claim 1, wherein
said power steering mechanism includes an electric motor,
said power steering control means computes a corrected vehicle speed by correcting a vehicle speed according to said steering angle correction amount, and sets an assist current of said electric motor based on a steering torque and said corrected vehicle speed, and drives said electric motor at said assist current.

5. The vehicle steering control system according to claim 4, wherein
said vehicle speed correction amount is set based on at least one of a steering wheel angle, a first order differential value of the steering wheel angle, and a second order differential value thereof.
